(19) United States
(12) Patent Application Publication
(10) Pub. No.: US 2018/0333810 A1
(43) Pub. Date: Nov. 22, 2018

(54) METHOD FOR THE PRODUCTION OF A METAL COMPONENT, IN PARTICULAR A VANE COMPONENT OF A TURBOMACHINE

(71) Applicant: LEISTRITZ TURBINENTECHNIK NÜRNBERG GMBH, Nurnberg (DE)

(72) Inventors: Georg SCHMIDT, Schwabach (DE); Cindy LIEBL, Wendelstein (DE)

(21) Appl. No.: 15/979,736

(22) Filed: May 15, 2018

(30) Foreign Application Priority Data
May 17, 2017 (DE) 10 2017 110 735.5

(51) Int. Cl. B23P 15/04; F01D 9/04

(52) U.S. Cl. CPC B23P 15/04; F05D 2240/12; F05D 2230/11; F01D 9/041

(57) ABSTRACT

A method for producing of a metal component that is electrochemically machined to remove material, wherein an electrode is positioned adjacent to and, by a duct gap, spaced from a component portion to be machined, and in the presence of an electrolyte a current and a voltage are applied to the electrode and the component. The electrode is moved toward the component from an initial position to a terminal position. In a first operating mode material is removed using a permanently applied current and voltage, a constant electrolyte flow through the duct gap, and a constant advancement of the electrode from the initial position toward the component while maintaining a first gap width. Upon achieving a predetermined removal depth, a changeover to a second operating mode occurs and the electrode is moved cyclically between a non-operating position and an operating position having a second gap width smaller than the first gap width. A current pulse and voltage pulse are applied only in the operating position, and the electrolyte flows through the gap at least in the non-operating position. The second operating mode is maintained until a desired final geometry.

### CROSS-REFERENCE TO RELATED APPLICATIONS

The present application claims priority of DE 10 2017 110 735.5, filed May 17, 2017, the priority of this application is hereby claimed and this application is incorporated herein by reference.

### BACKGROUND OF THE INVENTION

The invention relates to a method for the production of a metal component, in particular a vane component of a turbomachine, which for generating a three-dimensional shape is electrochemically machined in order for material to be subtracted, to which end at least one electrode is positioned so as be adjacent to and, by way of a duct gap, spaced apart from a component portion to be machined, and in the presence of an electrolyte a current is applied to the electrode and the component, and the electrode is moved in the direction of the component from an initial position to a terminal position.

A method for electrochemical subtraction (ECM-electrochemical machining) is used for processing metallic workpieces which are composed of an electrically conductive material when complex geometries are to be generated. A vane component of a turbomachine, for example a jet engine vane, or similar, is an example of a workpiece that can be produced by such ECM processing.

An ECM method is a reproduction method that does not remove chips. A device that serves this purpose comprises one, in most instances a plurality of, electrodes which by means of a suitable linear drive unit are movable in a linear manner from an initial position, in the case of an as yet non-machined workpiece, to a terminal position having a workpiece that then is machined. These movable electrodes form respective cathodes while the workpiece forms the anode. A duct gap which encircles the workpiece in a closed manner such that an electrolyte which absorbs and transports away the released material can circulate or flow, respectively, in said duct is formed during the entire reproduction method between the reproduction faces that are directed toward the workpiece and define the three-dimensional final geometry which the workpiece is intended to have, and the material surface per se.

In order for the metal component to be machined it is known for the one electrode or the plurality of electrodes to be continuously moved from the initial position thereof to the terminal position at a permanently applied current and a permanently applied voltage and a constant electrolyte flow. A continuous subtraction of material takes place until the final contour to be attained is achieved. This processing mode is referred to a “generator sinking”.

Should an extremely high reproduction accuracy and a high surface quality be desired, generator sinking is succeeded by a second processing step, the so-called PECM method (precision electrochemical machining). In the case of this method, the current and the voltage are applied so as to be pulsed at a frequency of usually 5 to 10 Hz, this thus being a pulsed method. The electrode by way of the drive motor is readjusted at this specific frequency between an operating position at which the current pulse is applied, and a non-operating position at which the current and the voltage are not applied and which it is spaced somewhat further apart from the workpiece. This readjustment serves for briefly enlarging the duct gap which in the PECM method is narrower as compared to generator sinking, so that the electrolyte can better flush out the subtracted products. Since the electrodes during the actual subtraction of material are even closer to the workpiece, the reproduction accuracy is even more precise and the surface quality is even better.

Should PECM processing take place after an initial processing by generator sinking, it is necessary for the already machined workpiece to be retrieved from the ECM device that carries out the first method step and to be inserted into a device in which the PECM method is carried out. This changeover is problematic to the extent that said changeover is complex, on the one hand, and the workpiece has to be re-clamped in the PECM device, on the other hand, the latter potentially leading to minute positioning inaccuracies and thus to reproduction defects. Furthermore, new electrodes are used in the second ECM device.

### SUMMARY OF THE INVENTION

The invention is thus based on the object of specifying a method which is improved as compared to methods known to date.

In order for this object to be achieved it is provided according to the invention in the case of a method of the type mentioned at the outset that
the material in a first operating mode is subtracted by way of a permanently applied current and a permanently applied voltage, a constant electrolyte flow through the duct gap, and a constant advancement of the electrode from the initial position in the direction of the component while maintaining a first gap width, and that
by achieving a predetermined subtraction depth, an automatic changeover to a second operating mode takes place in that the electrode is moved in a cyclical manner between a non-operating position and an operating position having a second gap width which is smaller than the first gap width, wherein a current pulse and voltage pulse are applied only in the operating position, and the electrolyte flows through the gap at least in the non-operating position, wherein the second operating mode is maintained until the final geometry to be generated has been achieved.

It is provided according to the invention that the ECM processing of the workpiece is carried out in a single pass in a single ECM device. According to the invention, two operating modes are directly sequential, that is to say that automatic switching takes place from the first to the second operating mode during the processing. Generator sinking is performed in the first operating mode, this meaning that a specific current and a specific voltage are permanently applied, and a permanent flow of electrolyte through the duct gap is also provided, and the or all electrodes, proceeding from the initial position, are continuously moved in the direction of the component. The processing is performed at a first gap width which is, for example, 0.2 to 0.3 mm. The “rough processing” is quasi performed in this first operating mode, the objective being a sufficiently large subtraction of material. This first operating mode takes place until a predetermined subtraction depth has been achieved, this being able to be detected by corresponding measuring technology. As soon as this predetermined subtraction depth has been achieved, an automatic changeover to the second operating mode takes places, the actual “fine processing” to the final contour dimension taking place in the context of said second operating mode. A pulsed operation is performed in the context of this second operating mode, that is to say that operating henceforth takes place by a PECM method, while generator sinking is carried out in the first operating mode. The current and the voltage in the second operating mode are applied only in a pulsed manner, specifically only when the or all electrodes are in the operating positions of the latter. The current and the voltage are switched on or off, depending on the pulse frequency, the electrode movement between the operating position, with the current and voltage being applied, and the non-operating position, with the current and the voltage switched off, being performed in a corresponding manner. The gap width in the operating position is significantly smaller than in the first operating mode, said gap width in the second operating mode being between 0.05 and 0.1 mm. This pulsed method is carried out until the final contour is achieved, the electrodes therefore having been moved to the terminal position.

According to the invention, a two-stage ECM method is subsequently carried out fully automatically by way of a single clamping of the workpiece and while using the same electrodes, in that generator sinking is carried out in a first operating mode, and PECM processing is carried out after having switched over to a second operation mode in a fully automatic manner. On account of the situation that the workpiece has neither to be changed over or inserted into another device, respectively, in order for the different operating modes to be carried out, nor that different electrodes are required for the generator sinking and the PECM operation, a swift operation is enabled on the one hand, and a high-precision operation is enabled on the other hand, since tolerances or complexities that arise from changing over one of the method components are specifically not encountered in the present case.

As has already been mentioned, the first gap width should be between 0.2 and 0.3 mm, and the second gap width should be between 0.03 and 0.1 mm.

The permanently applied current and the current pulse should be between 1500 and 20,000 A.

The permanently applied voltage and the voltage pulse should be between 6 and 200 V.

The frequency of the movement between the non-operating position and the operating position, and also the current and voltage pulse frequency, should be between 5 and 15 Hz.

The pressure of the electrolyte flowing through the duct gap should be between 5 and 20 bar, wherein the pressure varies in particular in the second operating mode, depending on the electrode position.

It is particularly advantageous for the electrode to be moved by way of the same drive motor in both the first and the second operating mode. This means that on the part of the EMC device which is designed to carry out both the first and the second operating mode, one and the same linear drive unit, or in the case of a plurality of electrodes the same linear drive units, respectively, are used in both the first and the second operating mode. In order for this to be enabled in a simple and highly precise manner, a torque motor is preferably used as a drive motor.

Should a plurality of electrodes be used, said plurality of electrodes are moved simultaneously relative to the component in the first and the second operating mode, wherein each electrode is moved, thus is able to be controlled separately, by means of a separate drive motor, preferably a torque motor. Whilst a coupling of the movements of two electrodes would be conceivable in principle, it is expedient for each electrode to be separately driven so as to be able to react to any potential situations in the method.

The electrodes, bearing on one another, preferably overlap one another on the periphery and delimit the gap encircling the component. This means that adjacent electrodes contact one another and engage across or overlap one another, respectively, on the periphery during the entire readjustment movement, independently of the operating mode being operated, such that said electrodes by way of the reproduction faces thereof which by virtue of the contact and overlap adjoin one another, delimit and seal the closed duct gap encircling the workpiece. Although the electrodes change the mutual relative positions thereof during the readjustment movement, since said electrodes are readjusted relative to the workpiece by dissimilar directions of movement, they remain in permanent contact, wherein the overlap increases during the readjustment movement since the electrodes converge even further by virtue of the subtraction of material. By virtue of the permanent contact the fluid duct also remains permanently delimited and tightly closed by way of the reproduction faces.

This leads to the entire workpiece region which is engaged across by the reproduction faces being permanently engaged across, meaning that each surface point of the workpiece portion which is engaged across by the plurality of mutually overlapping reproduction faces during the entire ECM processing has one opposite reproduction face both in the first operating mode and in the second operating mode. This in turn leads to the entire workpiece region which is engaged across by way of the mutually adjoining reproduction faces being able to be homogeneously machined; consequently, no edge or peripheral regions result at the transition from one electrode to another since there is also no electrode gap in this transition region by virtue of the engagement or overlap, respectively. Accordingly, the completely machined workpiece in the region machined by way of the reproduction faces displays a homogeneous processing pattern, and the quality of work is significantly improved as compared to previous work practices, specifically in terms of both the first and the second operating mode.

It is conceivable for at least three electrodes to be used, wherein the two outer electrodes slide along a positionally fixed sealing component that delimits the duct gap. In the case of this design embodiment of the invention, the duct gap is consequently externally closed by way of the reproduction faces of the three mutually contacting electrodes and the sealing component. During the readjustment movement of the electrodes which, for example, by way of the motion axes thereof are mutually orthogonal (this means that two electrodes are mutually opposite and are converged, while the central electrode is moved in a manner perpendicular thereto), the two outer electrodes slide on the sealing component until the terminal position is reached. In terms of the reproduction a vane component for a turbomachine, which has an elongate cross-sectional shape having a curved upper and lower side and edges with a relatively small radius, operating takes place by way of two electrodes which machines the upper and lower side, while the central electrode machines the one edge, this in the case of the method according to the invention by virtue of the overlap and thus of the configuration of a quasi large-area closed reproduction face being readily possible. On the opposite second edge, the processing of the workpiece edge is performed in that, for example, the two electrodes bear on one another and are converged in the terminal position, that is to say that a subtraction of material and simultaneously a shaping of the edge is performed there also.

An alternative to the use of such a sealing component is the use of four electrodes which bear on one another or overlap one another, respectively, and which delimit the duct gap encircling the component. Four separately movable electrodes are thus provided in the case of this design embodiment of the invention, the motion axes of said electrodes being mutually orthogonal, for example. In terms of the exemplary embodiment of the vane component, two electrodes configure the upper and the lower side of the workpiece, while the two other mutually opposite electrodes by way of the specific reproduction faces thereof configure the two vane edges. All four electrodes overlap one another; the two electrodes that configure the edges, by way of the reproduction faces thereof, preferably engage across the two electrodes that configure the upper and the lower side. In the case of this design embodiment, the duct gap is consequently delimited exclusively by way of the four interacting electrodes. Said four electrodes within the two operating modes are moved simultaneously and in a synchronized manner from the initial position to the terminal position.

In order for a permanent sealing of the duct to be ensured it is necessary for the respective electrode overlap to be sufficiently tight. In order for this to be enabled, but also for an exact sliding action of the electrodes along one another to simultaneously be enabled, respective sliding faces are configured on the reproduction face side on the electrode or electrodes so as to engage across the adjacent electrodes, said sliding faces bearing on respective sliding faces that are configured on the external side of the adjacent electrode and sliding along the latter. Sufficiently tight bearing that nevertheless enables sliding is guaranteed in this way. The electrodes are made from brass, for example, so that a material having positive sliding properties is used.

While a vane component for a turbomachine is preferably produced by way of the method according to the invention, said vane component apart from the vane part per se often also having a vane root and a shroud ring, wherein the vane part across the length thereof can also be slightly twisted, it is of course also conceivable for components shaped in a different manner to be produced by the method according to the invention.

Besides the method per se, the invention furthermore relates to a device for carrying out the method of the described type, comprising at least one electrode which by means of a drive motor is movable relative to a component which for generating a three-dimensional shape is to be electrochemically machined by subtracting material, to which end the electrode is positioned so as be, by means of a drive motor, adjacent to and, by way of a duct gap, spaced apart from a component portion to be machined, and in the presence of an electrolyte a current is applied to the electrode and the component, wherein the operation of the drive motor, a power generator, and a pump installation that conveys the electrolytes is controlled by means of a control installation. This device is distinguished in that the control installation is configured in such a manner that
the electrode in a first operating mode in the case of a permanently applied current and a permanently applied voltage, and a constant electrolyte flow through the duct gap, is movable at a constant advancement in the direction of the component while maintaining a first gap width, and that
the electrode by reaching a predetermined subtraction depth by way of an automatic changeover to a second operating mode is movable in a cyclical manner between a non-operating position and an operating position having a second gap width which is smaller than the first gap width, wherein a current pulse and voltage pulse is applied only in the operating position, and the electrolyte flows through the gap at least in the non-operating position, wherein the second operating mode is maintained until the final geometry to be generated has been achieved.

A central control installation which controls all the essential components that are required for the ECM operation is used in the case of this device. The control installation communicates with at least one respective sensor installation or measuring installation which enables the subtraction depth to be exactly determined, so as to, based on these items of information, detect the moment at which the automatic switchover from the first operating mode to the second operating mode takes place. The control installation by way of the switchover moment controls all relevant components in the respective manner that corresponds to the second operating mode so that changing over from the first to the second operating mode takes place without any delay. While it is possible for only one electrode to be provided when a workpiece is to be machined on only one side, it is preferable for at least three electrodes which are disposed so as to be offset around the circumference of the workpiece to be provided, said three electrodes by way of the mutually contacting reproduction faces thereof engaging across one another in portions during the entire adjustment movement from the initial position to the terminal position, and by way of the reproduction faces thereof delimiting a closed duct gap, or fluid duct, respectively, that encircles the circumference of the workpiece.

In order for the mutual relative movement of the electrodes to be enabled at a simultaneous tight overlap, an electrode that is provided between two electrodes on the reproduction face is expediently provided with two sliding faces by way of which said electrode slides on respective outer sliding faces of the two adjacent electrodes.

A vane component of a turbomachine is preferably produced by the device, said vane component having an upper and a lower side and two likewise mutually opposite edges. In the processing of such a workpiece it is conceivable herein that two mutually opposite electrodes have the reproduction faces reproducing the upper and lower side of the workpiece, while the at least one third electrode, disposed between said two mutually opposite electrodes, has a reproduction face that reproduces the edge region of the workpiece. For example, the third, central electrode engages across the two outer, first and second, electrodes. While the reproduction face of the first and of the second electrode has a very large area, since said reproduction faces reproduce the upper and the lower sides, the reproduction face of the third electrode in the portion in which said reproduction face configures the edge in the terminal position is embodied only so as to be relatively small since the edge in the case of converged electrodes has only a very small radius and represents only a small region of the face of the workpiece surface. The respective sliding faces adjoin said reproduction face portion so as to be adjacent to the latter, said sliding faces enabling the electrodes to be converged to the terminal position.

It is expedient, in particular for the production of such a vane part that has a complex curved and optionally twisted geometry, for a fourth electrode, lying opposite the third electrode, to be provided, said fourth electrode likewise having a reproduction face that reproduces the edge region of the workpiece. This electrode also engages peripherally across the first and the second electrode, for example, as does the third electrode.

In principle, three or four electrodes can thus be provided according to the invention, independently of the geometry of the workpiece.

If a vane component of a turbomachine, having a vane portion with a flat elongate cross section, is produced or machined, respectively, as a workpiece, as has been described, the first and the second electrode thus has reproduction faces that reproduce the flat upper and lower side, while the third and optionally the fourth electrode has reproduction faces that reproduce the edge region having a small radius.

Here too, it is conceivable, in the case of three electrodes, for the two outer electrodes to slide along a positionally fixed sealing component that delimits the fluid duct.

In a refinement of the invention it can be provided that the motion axes of the linear drive units of two adjacent electrodes are set at a mutual angle of 90°. An orthogonal arrangement of axes is thus chosen, that is to say that either the three or the four electrodes are moved in a mutually perpendicular manner when said electrodes are repositioned from the initial to the terminal position. Alternatively, it is also conceivable for the motion axes of the linear drive units of two adjacent electrodes to be set at a mutual angle of smaller than or greater than to 90°. This may be required depending on the type or geometry of the workpiece to be machined.

It is expedient for the linear drive units for readjusting the angle between the motion axes of two adjacent linear drive units to be movable along a circular path, wherein each linear drive unit is preferably movable along the circular path by way of a servomotor. This design embodiment of the invention enables a flexible mutually relative readjustment of the spatial directions of the motion axes, consequently a variation in terms of intermediate angles, such that a multiplicity of processing tasks can be met by one and the same device, always seen against the background of each processing task being able to be carried out by way of a first and a second operating mode.

The or each drive motor is preferably a torque motor which enables a highly precise positioning of the electrodes and movement of the electrodes, this being advantageous in particular for carrying out the pulsed PECM operation.

Furthermore, each electrode can be assigned a sensor installation that communicates with a control installation, wherein the sensor installation is preferably assigned to the linear drive unit. The position of the electrode can be detected by way of this sensor installation, wherein the control installation controls the operation depending on the sensor detection.

Furthermore, a positioning installation for automatically positioning the workpiece in the operating position in an operating chamber can be provided. This positioning installation can move the workpiece in a pure linear movement, for example vertically from above, into the operating chamber and fix said workpiece during the ECM processing. Therebesides, it is conceivable that the workpiece by means of the positioning installation is rotatable about the longitudinal axis of said workpiece during the transfer of the workpiece to the operating position and/or while the workpiece is located in the operating position. This enables any potential twisting of the vane portion to be followed and for a slight readjustment of the angle, for example by 1° maximum, to be performed even during processing, should this be expedient in terms of production technology.

Furthermore, a magazine into which a plurality of workpieces to be machined are introducible and which is assigned to the positioning installation can be provided, said workpieces being automatically retrievable by way of the positioning installation or a changeover installation. Said positioning installation, including the magazine, accordingly enables a fully automatic operation. A person operating the ECM device equips the magazine with the number of workpieces to be machined prior to the operation beginning. The positioning installation, or a changeover installation assigned to the former, automatically retrieves a workpiece to be machined from the magazine and in the case of a changeover installation transfers said workpiece to the positioning installation which thereafter transfers said workpiece to the operating chamber. Should the positioning installation per se move into the magazine, it is the positioning installation that thus transfers the workpiece directly to the operating chamber. The ECM processing is performed thereupon, the positioning installation at the end of said ECM processing again retrieving the machined workpiece from the operating chamber and transferring said workpiece either directly into the magazine or handing said workpiece over to the changeover installation which thereupon transfers the workpiece into the magazine. The next workpiece is thereupon acquired, etc. A fully automatic operation in which the operator following the stocking of the magazine has to trigger the start of the operation just once is thus provided. Thereafter, all manipulations up to the end of the operating cycle run fully automatically, said operating cycle ending in that the workpiece last machined is again transferred into the magazine.

In order to have a defined interface for the access of the positioning installation, or the changeover installation, respectively, in terms of the workpiece, it is expedient for each workpiece to be received in a workpiece holder which is acquirable by way of the positioning installation or the changeover installation. This workpiece holder has a defined coupling geometry by way of which said workpiece holder can be acquired in a defined manner by the changeover installation or the positioning installation.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1 shows a flow diagram for explaining the method according to the invention;

FIG. 2 shows a first electrode assembly of an ECM device having three electrodes in the initial position;

FIG. 3 shows the electrode assembly from FIG. 2 in the terminal position;

FIG. 4 shows a second electrode assembly of an ECM device having four electrodes in the initial position;

FIG. 5 shows the electrode assembly from FIG. 4 in the terminal position;

FIG. 6 shows a sectional partial view of an ECM device with an illustration of the electrodes and the linear drive units of the latter;

FIG. 7 shows a schematic illustration of an ECM device having pivotable linear drive units; and

FIG. 8 shows a schematic illustration of an ECM device having all components.

### DETAILED DESCRIPTION OF THE INVENTION

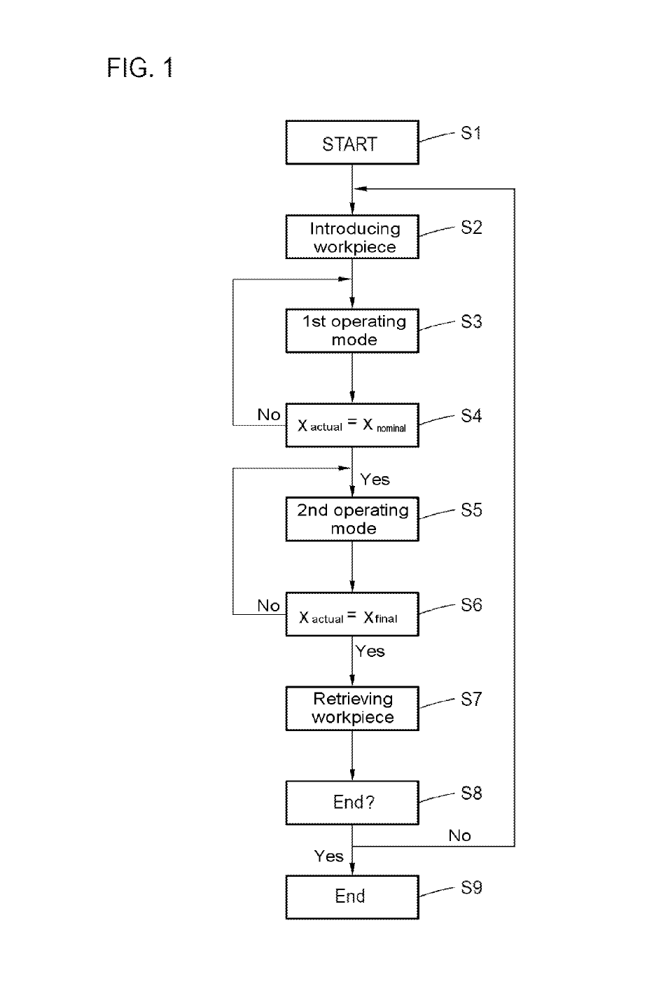

FIG. 1 in the form of a flow diagram shows the substantial steps of the method according to the invention.

The method starts at step S1; the person operating the device triggers the start of the operation. Prior thereto, the person has stocked any potential magazine that is assigned to a positioning installation of the device with the number of workpieces to be machined in the entire operating cycle.

After the start of the operation, the introduction of a workpiece to be machined into the operating chamber is performed in step S2. To this end, the positioning installation, for example, or a changeover installation, can retrieve a workpiece from the magazine and hand said workpiece over to the positioning installation. In any case, the workpiece is introduced into the operating chamber of the device by way of the positioning installation, the ECM processing being performed in said operating chamber.

Having introduced the workpiece into the operating chamber and tightly closed the operating chamber, the ECM processing is performed thereafter. According to step S3, the processing in the first operating mode is performed first. In this operating mode, the so-called generator sinking, feeding of the electrodes is performed in a constant manner at a duct gap width of approx. 0.2 to 0.3 mm, and with a permanently applied current in the range of several 1000 A, a permanently applied voltage of approx. 6 to 200 V, and a permanent flow of electrolyte, that is to say that the electrodes by way of a more or less constant advancement are moved in the direction of the component, the electrochemical subtraction of material being performed during said movement. The subtracted products are discharged from the duct gap by way of the flow of electrolyte.

The subtraction depth which in FIG. 1 is illustrated by xactual is permanently detected during the first operating mode (see step S4). It is permanently checked whether the actual subtraction depth corresponds to a predetermined subtraction depth xnominal, attaining the latter corresponding to the switchover moment at which a switchover to the second operating mode is to take place. A suitable measuring or sensor installation, or a corresponding plurality of such installations, is provided for detecting the subtraction depth, the electrode position, for example, being able to be exactly detected by said installation or installations, on account of which, proceeding from the initial position of the electrode(s) it can be determined how much material has been subtracted, or how large the subtraction depth is, respectively.

If the result is that xactual ≠ xnominal, the first operating mode according to step S3 is thus continued.

However, if the result is that xactual=xnominal, the central control installation controlling the operation of the ECM device immediately switches over to the second operating mode according to step S5. A pulsed ECM operation is run in this second operating mode. The current, here also in the range of several 1000 A, and the voltage in the range from 6 to 200 V, is now applied only in a pulsed manner, the pulse frequency being in the range between 5 and 15 Hz. The electrode or electrodes by way of the respective drive motor, preferably a torque motor, of the linear drive units that move the electrodes is or are readjusted at a corresponding frequency between an operating position, in the case of a current being applied, and a non-operating position, in the case of a current being absent. The gap width of the duct gap in the operating position is significantly smaller than in the first operating mode, said gap now being only in the range between 0.03 and 0.1 mm. On account of this pulsed operation, a highly precise reproduction and an outstanding surface quality of the machined workpiece can be obtained.

A permanent detection of the subtraction depth xactual is also performed in the second operating mode according to step S6. Said subtraction depth xactual is in turn compared to a comparison depth, presently the final depth xfinal which simultaneously marks the attainment of the terminal position of the electrode feed. This permanent detection of the position is in turn also performed by way of the control installation and by way of the measuring or sensor installations which have already performed the detection of the position in the first operating mode.

If the result is that xactual ≠ xfinal, the second operating mode according to step S5 is thus continued in a permanent manner.

If the result is that xactual=xfinal, the entire ECM procedure is terminated. According to step S7, the retrieval of the machined workpiece from the operating chamber is performed by way of the positioning installation, wherein the workpiece is then transferred into the magazine again by way of the positioning installation or by way of the changeover installation.

It is thereafter checked in step S8 whether the entire method, or the cycle, respectively, has been terminated by processing the last workpiece. In the affirmative, the operating method is completely terminated according to step S9. Otherwise, the routine reverts back to before step S2, that is to say that a new workpiece is acquired and introduced by way of the positioning installation or the changeover installation, the further steps adjoining here.

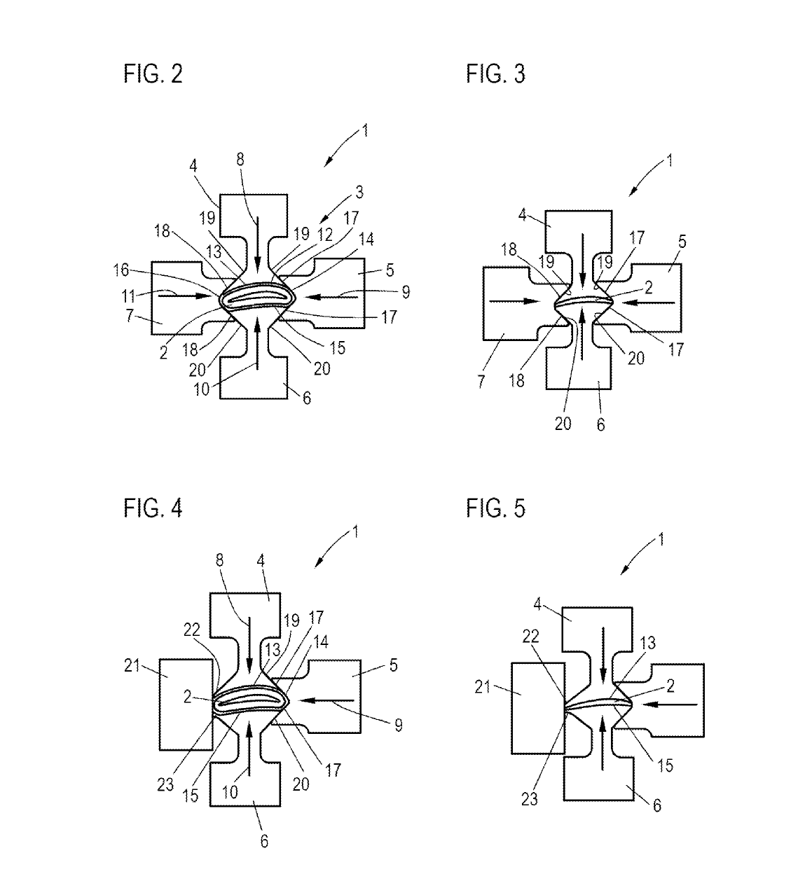

FIG. 2 as part of a device 1 according to the invention for electrochemically machining a metal workpiece 2 shows an electrode assembly 3, in the example shown comprising four separate electrodes 4, 5, 6, 7 which are all movable relative to the workpiece 2 by way of separate linear drive units (not shown in more detail here). The electrodes 4 to 7 form cathodes, while the workpiece 2 forms the anode. The electrodes 4 to 7 are movable in a linear manner along the motion axes 8, 9, 10, 11 by way of the linear drive units, wherein the motion axes 8 to 11 in the exemplary embodiment shown are mutually perpendicular.

When in operation, a permanent, closed, gap-type fluid duct 12 that encircles the workpiece 2 (shown in the cross section here) is provided, said fluid duct 12 in the exemplary embodiment shown being delimited radially, or externally, respectively, and sealed exclusively by way of the reproduction faces 13, 14, 15, 16 of the electrodes 4 to 7. An electrolyte which serves for the electrochemical machining of the workpiece 2 and by way of which subtracted products are simultaneously transported out of the fluid gap 12 flows in a manner perpendicular to the illustration plane under suitable pressure through the fluid duct 12.

FIG. 2 shows the initial position with the as yet still non-machined workpiece 2. As can be seen, the electrodes 4 to 7 engage in one another, or mutually overlap in a peripheral manner, respectively. To this end, the mutually opposite electrodes 5 and 7 on the peripheries have planar sliding faces 17 and 18, respectively, which externally bear in a contacting and sealing manner on corresponding sliding faces 19, 20 of the likewise mutually opposite electrodes 4 and 6. Mutually interacting sliding faces are thus provided on adjacent electrodes. Having engaged in each case across two adjacent electrodes 4 and 6, the electrodes 5 and 7 in the region of the reproduction face have a quasi V-shaped geometry, wherein the actual reproduction geometry which is intended to reproduce the rounded edge of the workpiece 2 is configured between the sliding faces 17 and 18, respectively.

Each reproduction geometry 13 to 16 is in portions embodied in such a manner that said reproduction geometry in the terminal position shows the negative of the face portion of the completely machined workpiece 2 which is to be machined by the respective electrode 4 to 7. In the case of the electrodes 4 and 6, this is the upper and the lower side of the workpiece 2, the latter being a vane component for a turbomachine. In the case of the electrodes 5 and 7, these are the corresponding two edges of the workpiece 2 that have a small radius.

As described, FIG. 2 shows the electrode assembly 3 at the start of the actual ECM operation. The electrodes 4 to 7 are diverged to a relatively large extent; the degree of overlap is not yet very high. Thereafter, upon switching on the conveyance of electrolyte and applying the current and the voltage, the electrodes 4 to 7 in a first operating mode, the so-called “generator sinking”, with a constantly applied current and voltage, and by way of a linear adjustment path, are moved in a linear manner in the direction of the motion axes 8 to 11, thus in the direction of the arrows, and consequently pushed toward one another. By virtue of the current applied, which can be several 1000 ampees, and the voltage, which can be between 6 and 200 V, a subtraction of the workpiece material according to the ECM method takes place on the surface of said workpiece, that is to say that the workpiece volume is reduced. The respective surfaces are shaped by the respective opposite portions of the reproduction faces 13 to 17 of the respective electrodes 4 to 7.

The linear readjustment movement at a constant current and voltage in the first operating mode (generator sinking) is maintained until a defined sink depth, thus a defined intermediate position, has been attained. This is detected by way of a suitable measuring technology or sensor system. Thereafter, an automatic switchover to a second operating mode, the so-called PECM mode, is performed by way of the central control installation. In said second operating mode, the current and the voltage are applied only in a pulsed manner at a frequency of 5 to 15 Hz, for example. A current pulse is applied when the respective electrode is in the operating position. When the current is switched off, the electrode is slightly moved away from the workpiece 2 such that the fluid duct 12 is opened wider, the gap width thus being somewhat enlarged, enabling the electrolyte to better flow therethrough. Thereafter, the respective electrode is fed again and moved to the operating position, whereupon a current is applied again, etc. An intermittent operation is thus provided both in terms of the current and in terms of the positioning of the electrode. It is to be noted herein that the gap width in the first operating mode, thus in generator sinking, is slightly larger than in the second operating mode, thus in the PECM operation. While the gap width in the first operating mode is approx. 0.2 to 0.3 mm, said gap width in the second operating mode is, for example, 0.05 to 0.1 mm when a current is applied, thus consequently when subtracting takes place. The gap width in the second operating mode is enlarged to, for example, 0.2 to 0.3 mm, by diverging the electrodes.

Two different operating modes are thus performed within a single processing procedure, that is to say a readjustment procedure, from an initial position shown in FIG. 2 to the terminal position shown in FIG. 3, in which the electrodes 4 to 7 are converged to a large extent (cf. FIG. 3). The overlap regions of the sliding faces 17, 18, and 19, 20 are accordingly greatly enlarged as compared to the initial position. As can be seen, the reproduction faces 13 to 16, by way of the face portions that define the final contour of the workpiece 2 after the ECM processing, that is to say the portions in the region of the upper and the lower side and in the region of the two edges, are mutually complementary, defining the unequivocal three-dimensional final geometry that is reproduced on the workpiece 2. As the electrodes 4 to 7 are in mutual contact during the entire readjustment procedure from the initial position according to FIG. 2 to the terminal position according to FIG. 2 and seal the fluid gap 12, this final geometry is extremely homogeneous across the entire circumference of the workpiece, since a reproduction face of the respective adjacent electrode is opposite each location around the circumference of the workpiece 2, a subtraction of material accordingly taking place at each position. This subtraction of material that takes place at each position is ensured during the entire readjustment movement, independently of the operating mode, such that an extremely homogeneous subtraction and thus also an extremely homogeneous surface pattern can be achieved.

The respective electrodes 4 to 7 extend across the entire length of the workpiece to be machined, the latter in the example shown being a vane part of a turbomachine. Said vane part at the front and the rear end is delimited by way of a vane root and a shroud ring, the electrodes 4 to 7 plunging therebetween.

FIGS. 4 and 5 show a further partial view of an ECM device 1 according to the invention, wherein the same reference signs are used for the same components. Only three electrodes 4, 5, 6 are provided here, said electrodes 4, 5, 6 having respective reproduction faces 13, 14, 15. As is the case in the design embodiment according to FIGS. 2 and 3, the electrode 5 by way of the sliding faces 17 thereof engages across the respective adjacent sliding faces 19 and 20 of the electrodes 4 and 6.

In the case of this embodiment, only one electrode 5 that reproduces on the edge is provided. A positionally fixed duct component 21 is provided on the opposite side, the two electrodes 4 and 6 by way of edge portions 22, 23 (shaped somewhat differently here) bearing in a sliding and sealing manner on said duct component 21.

Here too, the electrodes 4 to 6 by way of respective linear drive units are capable of being converged in a linear manner along the motion axes 8, 9, 10, said electrodes 4 to 6 by way of the sliding faces 17, 19, and 20 sliding on one another, while the electrodes 4, 6 by way of the edge regions 22, 23 thereof slide on the duct component 21. In the terminal position shown in FIG. 5, the degree of overlap of the electrodes 5 with the electrodes 4 and 6 has again been significantly enlarged, in a manner similar to the exemplary embodiment according to FIGS. 2 and 3. The edge portions 22, 23 of the electrodes 4, 6 bear on one another on the opposite edge side of the workpiece 2. By virtue of the geometry of the respective reproduction faces 13, 15 of the two electrodes 4, 6 in the transition toward the edge portions 22, 23 it is possible also in the case of this design embodiment having only three electrodes for the edge of the workpiece 2 in this region to be configured in a rounded manner so as to correspond to a predefined geometry.

FIG. 4 in an enlarged detailed view again shows a fragment of an ECM device 1 according to the invention, having a machine frame 24 on which an operating chamber 25 in which the actual ECM processing takes places is provided. Shown in an exemplary manner are the four electrodes 4, 5, 6, 7 and the respective linear drive units 26, 27, 28, 29.

Each linear drive unit 26 to 29, of which only one will be described hereunder as the drive units are of a fundamentally identical construction, comprises a drive motor 30 in the form of a torque motor 31, comprising a drive spindle 32 to which an electrode holder 33 that is displaceable in a linear manner is connected. The drive spindle having an external thread is rotated by way of the torque motor 31. Said drive spindle is guided in a positionally fixed nut 34 and coupled to the electrode holder 33. Depending on the direction of rotation of the spindle, the electrode holder 33 is conjointly moved in a linear manner with the spindle 32 in the case of the spindle being rotated. The respective feed of the individual electrodes 4 to 7 is performed in this way. The construction, or the configuration, respectively, of the linear drive units 26 to 29 shown is merely exemplary. Other linear movement concepts are also conceivable; however, a common factor therein should be a torque motor 31 which enables a very rapid intermittent positioning operation (because the latter is at a higher frequency) required for the PECM operation and also allows highly precise positioning, on the other hand.

All linear drive units 26 to 29 are separately actuatable, meaning that the superordinate control installation actuates each torque motor 31 separately such that the movement of the electrodes can be performed in an optimal manner.

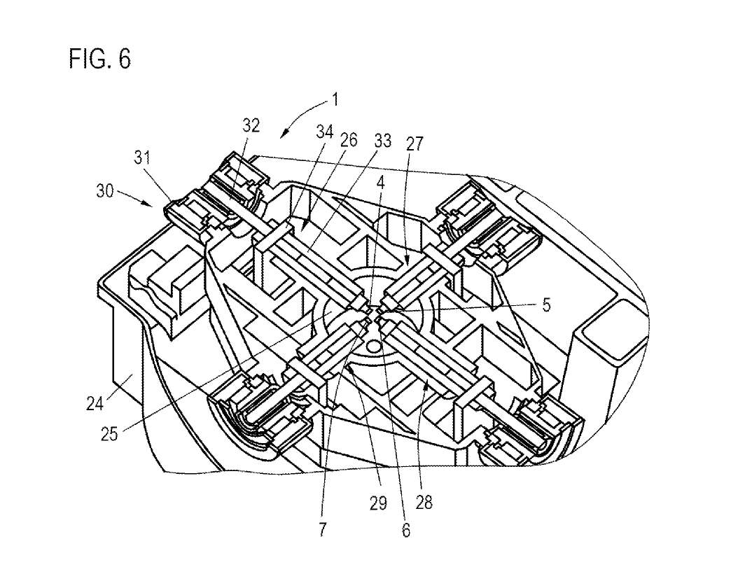

The linear drive units 26 to 29 in the case of the design embodiment according to FIG. 6 are positionally fixed. The torque motors 31 are thus immobile; only the spindles 32 and the electrode holders 33 are guided so as to be movable in a linear manner. This means that the angle between the motion axes of the linear drive units 26 to 29 is fixed, said angle being 90°, as is shown in an exemplary manner in FIG. 2.

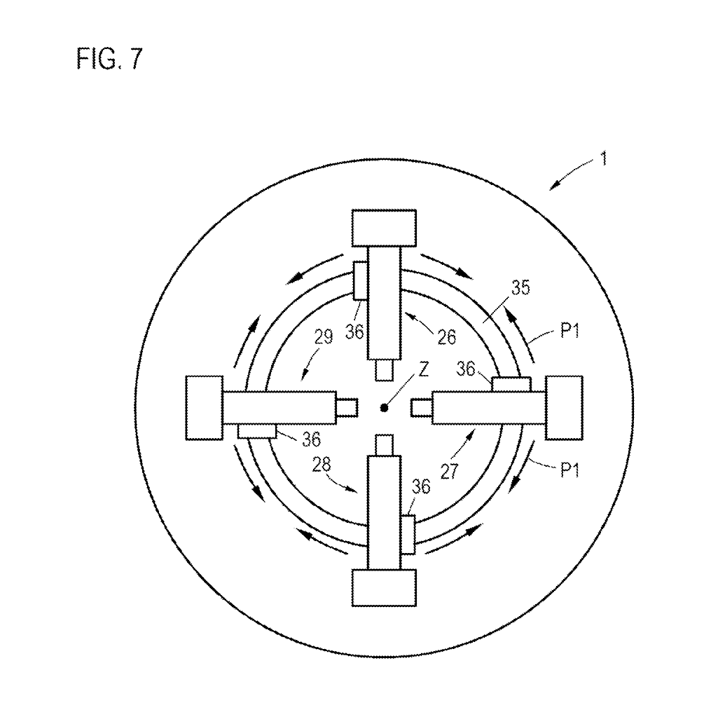

In order for there to be a potential for variation in terms of the axis angle, a partial view of a device 1 in which the individual linear drive units 26 to 29 are movable along a circular path (as is represented by the arrows P1) is shown in FIG. 7. To this end, for example, a circular guide path 35 on which the linear drive units 26 to 29 are mounted by way of separate slide components or similar (not shown in more detail here) is provided. Said slide components are rotatable about the center Z which lies in the center of the operating chamber 25. This is performed in an exemplary manner by way of a respective actuator or drive motor 36, preferably in the form of a torque motor or servomotor which each of the linear drive units 26 to 29 shown there has.

In this way, it is possible for the relative mutual angle of the linear drive units 26 to 29 to be readjusted in relation to one another should this be required for reasons of the geometry of the workpiece or of the electrode geometry of the replaceable electrodes, respectively.

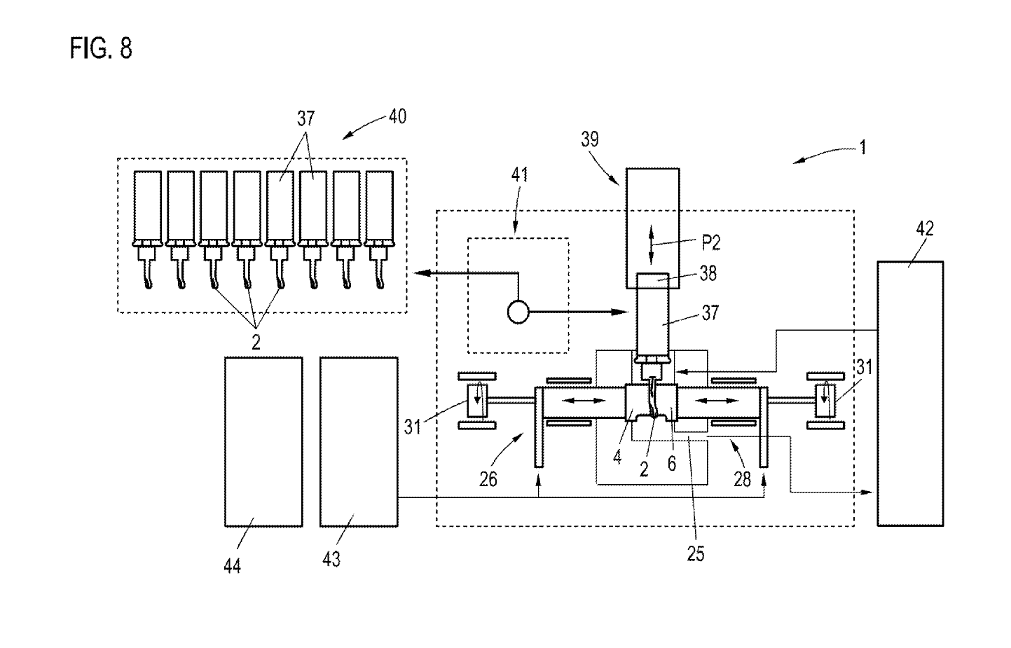

FIG. 8 finally shows a schematic illustration of a device 1 according to the invention for carrying out the ECM method. Only the two linear drive units 26, 28 are shown in an exemplar manner here; the other two linear drive units are orthogonal to the former. Also illustrated are the two assigned electrodes 4, 6 and the workpiece 2 that is located therebetween.

The workpiece 2 is received or clamped, respectively, in a workpiece holder 37 which is acquired by a receptacle installation 38 of a positioning installation 39, or is clamped therein, respectively. The positioning installation 39 has a respective spindle (not shown) on which the receptacle installation 38 is disposed. By way of said receptacle installation 38 it is possible for the workpiece 2 to be moved into and out of the operating chamber 25, as is illustrated by the double arrow P2.

It is conceivable herein that the spindle, or the receptacle installation 38, respectively, to be rotated about the longitudinal axis thereof while the workpiece 2 is moved to the operating position, and/or while the workpiece is located in the operating position, such that the workpiece in the case of a respective twist thereon can be threaded between the electrodes 4 to 7.

A magazine 40 and an optimal changeover installation 41, illustrated by dashed lines here, are furthermore assigned to the positioning installation 39. A plurality of workpieces 2 to be machined, which are already fixedly disposed on respective workpiece holders 37, are received in the magazine 40. This magazine 40 can be stocked in advance by the person overseeing the device 1. When in operation, the changeover installation 41 acquires the respective workpiece holder 37 of the next workpiece to be machined, for example, and transfers said workpiece holder 37 to the positioning installation 39 which acquires said workpiece holder 37 by way of the receptacle installation 38 which is coupled to the spindle (not shown in more detail). The changeover operation of a machined workpiece 2 after processing is performed in the reverse order, said machined workpiece 2 by way of the changeover device 41 being retrieved from the positioning installation 39 and transferred into the magazine 40.

Furthermore shown is a conveying and supplying installation 42 by way of which the electrolyte required for the ECM operation is supplied to the operating chamber 25 and discharged from the latter again in a closed circuit. The installation 42 comprises a suitable pump which makes available the required operating pressure.

Furthermore illustrated is the power supply 43, comprising a generator by way of which the electrodes 4 to 7, which form the cathodes, and the workpiece 2, which forms the anode, are supplied with the required operating current of several 100 to several 1000 amperes.

Furthermore shown is a central control installation 44 which controls the operation of all operating components of the device 1 according to the invention, thus the power supply installation 43 or the generator, respectively, the installation 42 for the supply of electrolyte, the positioning installation 39, and the changeover installation 41. Assigned to said central control installation 44 are respective sensor installations which determine corresponding operating or position parameters, etc., the control installation 44 controlling the operation based on said parameters. The measuring or sensor installations comprise respective sensors for the highly accurate detection of the respective electrode position, this being required for the actuation operation of the torque motors 31 in both operating modes. Moreover, the respective positioning of the electrodes in the operating positions, or the deployed positions, in the PECM operation, etc., is also controlled by way of said control installation 44. The same applies of course to the positioning installation 39; here, the respective occupation of the terminal position of the workpiece 2, thus the operating position, is detected, such as of course also respective positionings or completions of procedures in the context of the changeover of parts, etc.

Furthermore, a highly precise actuation of the power supply 43, thus of the generator, is required in the PECM operation, since the latter is only pulsed. The pulse frequency of the generator 43, and thus also the frequency at which the torque motors 31 retract and deploy the electrodes, is in the range of usually 5 to 10 Hz, but can also be higher, for example up to 15 Hz.

The control installation 44 is in particular responsible for switching the operating mode of the device 1 according to the invention from the first operating mode, in which the electrodes 4 to 7 with a permanently and usually constantly applied current are preferably fed in a constant manner, to the second operating mode, the PECM operation, in which a pulsed subtraction of material is performed. The trigger which serves for switching over from the first to the second operating mode is the detection of a corresponding position or intermediate position which is occupied by the electrodes 4 to 7 and which indicates that sufficient material has been subtracted by way of the respective electrode. A quasi rough subtraction by way of a relatively large subtraction of material is thus performed in the first operating mode, while the fine processing to the final contour is performed in the second, pulsed PECM mode. All this is performed in a single device by the operating mode switchover, and in a single motion cycle, and in a single clamping, meaning that the workpiece 2 remains at all times in one and the same position, and consequently does not have to be re-clamped, despite two different operating modes being carried out. This applies of course also to the electrodes 4 to 7 which are likewise used in the same position without any changeover procedure during both operating modes.

While specific embodiments of the invention have been shown and described in detail to illustrate the inventive principles, it will be understood that the invention may be embodied otherwise without departing from such principles.

We claim:

1. Method for the production of a metal component, in particular a vane component of a turbomachine, which for generating a three-dimensional shape is electrochemically machined in order for material to be subtracted, to which end at least one electrode is positioned so as be adjacent to and, by way of a duct gap, spaced apart from a component portion to be machined, and in the presence of an electrolyte a current and a voltage are applied to the electrode and the component, and the electrode is moved in the direction of the component from an initial position to a terminal position, wherein
the material in a first operating mode is subtracted by way of a permanently applied current and a permanently applied voltage, a constant electrolyte flow through the duct gap, and a constant advancement of the electrode from the initial position in the direction of the component while maintaining a first gap width, and in that
by achieving a predetermined subtraction depth, an automatic changeover to a second operating mode takes place in that the electrode is moved in a cyclical manner between a non-operating position and an operating position having a second gap width which is smaller than the first gap width, wherein a current pulse and voltage pulse are applied only in the operating position, and the electrolyte flows through the gap at least in the non-operating position, wherein the second operating mode is maintained until the final geometry to be generated has been achieved.

2. The method according to claim 1, wherein the first gap width is between 0.2 and 0.3 mm, and the second gap width is between 0.03 and 0.1 mm.

3. The method according to claim 1, wherein the permanently applied current and the current pulse are between 1500 and 20,000 A.

4. The method according to claim 1, wherein the permanently applied voltage and the voltage pulse are between 6 and 200 V.

5. The method according to claim 1, wherein the frequency of the movement between the non-operating position and the operating position, and the current pulse frequency, are between 5 and 15 Hz.

6. The method according to claim 1, wherein the pressure of the electrolyte flowing through the duct gap is between 5 and 20 bar.

7. The method according to claim 1, wherein the electrode is moved by way of the same drive motor in both the first and the second operating mode.

8. The method according to claim 7, wherein a torque motor is used as a drive motor.

9. The method according to claim 1, wherein a plurality of electrodes are moved simultaneously relative to the component in the first and the second operating mode, wherein each electrode is moved by means of a separate drive motor.

10. The method according to claim 9, wherein the electrodes, bearing on one another, overlap one another on the periphery and conjointly delimit the gap.

11. The method according to claim 10, wherein at least three electrodes are used, wherein the two outer electrodes slide along a positionally fixed sealing component that delimits the duct gap.

12. The method according to claim 10, wherein four electrodes which delimit the duct gap encircling the component are used.

13. A device for carrying out the method according to claim 1, comprising at least one electrode which by means of a drive motor is movable relative to a component which for generating a three-dimensional shape is to be electrochemically machined by subtracting material, to which end the electrode is positioned so as be, by means of a drive motor, adjacent to and, by way of a duct gap, spaced apart from a component portion to be machined, and in the presence of an electrolyte a current and a voltage are applied to the electrode and the component, wherein the operation of the drive motor, a power generator, and a pump installation that conveys the electrolytes is controlled by means of a control installation, wherein the control installation is configured in such a manner that
the electrode in a first operating mode in the case of a permanently applied current and a permanently applied voltage, and a constant electrolyte flow through the duct gap, is movable at a constant advancement in the direction of the component while maintaining a first gap width, and that
the electrode by reaching a predetermined subtraction depth by way of an automatic changeover to a second operating mode is movable in a cyclical manner between a non-operating position and an operating position having a second gap width which is smaller than the first gap width, wherein a current pulse and voltage pulse is applied only in the operating position, and the electrolyte flows through the gap at least in the non-operating position, wherein the second operating mode is maintained until the final geometry to be generated has been achieved.

14. A device according to claim 13, wherein at least three electrodes which are disposed so as to be offset around the circumference of the workpiece are provided, said three electrodes by way of the mutually contacting reproduction faces thereof engaging across one another in portions during the entire adjustment movement from the initial position to the terminal position, and by way of the reproduction faces thereof delimiting a closed duct gap that encircles the circumference of the workpiece.

15. A device according to claim 14, wherein an electrode that is provided between two electrodes on the reproduction face has two sliding faces by way of which said electrode slides on respective outer sliding faces of the two adjacent electrodes.

16. A device according to claim 14, wherein two mutually opposite electrodes have the reproduction faces reproducing the upper and lower side of the workpiece, while the at least one third electrode, disposed between said two mutually opposite electrodes, has a reproduction face that reproduces the edge region of the workpiece.

17. A device according to claim 16, wherein a fourth electrode, disposed opposite the third electrode, is provided, said fourth electrode likewise having a reproduction face that reproduces the edge region of the workpiece.

18. A device according to claim 14, wherein in the case of three electrodes the two outer electrodes slide along a positionally fixed sealing component that delimits the fluid duct.

19. A device according to claim 14, wherein in the case of four electrodes two mutually opposite electrodes engage across the two other electrodes.

20. A device according to claim 14, wherein the motion axes of the linear drive units of two adjacent electrodes are set at a mutual angle of 90°, or in that the motion axes of the linear drive units of two adjacent electrodes are set at a mutual angle of smaller than greater than to 90°.

21. A device according to claim 14, wherein the linear drive units for readjusting the angle between the motion axes of two adjacent linear drive units are movable along a circular path, wherein each linear drive unit is preferably movable along the circular path by way of a servomotor.

22. A device according to claim 13, wherein the or each drive motor is a torque motor.

23. A device according to claim 14, wherein each electrode is assigned a sensor installation that communicates with a control installation, the position of the electrode being detectable by way of said sensor installation, wherein the control installation controls the operation depending on the sensor detection.

24. A device according to claim 13, wherein a positioning installation for automatically positioning the workpiece in the operating position in an operating chamber is provided.

25. A device according to claim 24, wherein the workpiece by means of the positioning installation is rotatable about the longitudinal axis of said workpiece during the transfer of the workpiece to the operating position and/or while the workpiece is located in the operating position.

26. A device according to claim 24, wherein a magazine into which a plurality of workpieces to be machined are introducible and which is assigned to the positioning installation is provided, said workpieces being automatically retrievable by way of the positioning installation or a changeover installation.

27. A device according to claim 26, wherein each workpiece is received in a workpiece holder which is acquirable by way of the positioning installation or the changeover installation.
